(19) United States
(12) Patent Application Publication
(10) Pub. No.: US 2025/0137321 A1
(43) Pub. Date: May 1, 2025

(54) UNIDIRECTIONAL DAMPER DISPOSED INSIDE THE MOTOR OF A CORELESS WINDOW CURTAIN

(71) Applicants: BEAUTIFUL WINDOW FASHIONS CO., LTD., CHANGHUA COUNTY (TW); TAICHANG KINGFU PLASTIC MANUFACTURE CO., LTD., TAICANG (CN)

(72) Inventors: SZU-CHANG HUANG, CHANGHUA COUNTY (TW); ZHUO CAI, TAICANG (CN)

(21) Appl. No.: 18/779,887

(22) Filed: Jul. 22, 2024

(30) Foreign Application Priority Data
Oct. 25, 2023 (TW) 112211556

(51) Int. Cl. E06B 9/322

(52) U.S. Cl. CPC E06B 9/322; E06B 2009/3222; E06B 2009/3225

(57) ABSTRACT

The present invention provides a unidirectional damper disposed inside the motor of a coreless window curtain. The coreless window curtain comprises an upper beam, a lower beam, and a plurality of slats serially connected between the upper beam and the lower beam through several releasing and winding straps. The motor is disposed inside the lower beam and is connected with the releasing and winding straps to control the movement of the releasing and winding straps and to keep the horizontal level of the lower beam. Through an elastic force, the releasing and winding straps can be smoothly released or winded up, and the lower beam can stop at any position. The unidirectional damper is disposed inside the motor to enhance the braking power of the motor.

### BACKGROUND OF INVENTION

### 1. Field of the Invention

The present invention relates generally to a coreless window curtain, and more particularly to a unidirectional damper disposed inside the motor of a coreless window curtain.

### 2. Description of Related Art

Based on different structures, conventional window curtains can be categorized into pulling rope window curtains and coreless window curtains. A pulling rope window curtain has a pulling rope outside the curtain, when pulled, it can extend or fold the curtain. In comparison, in the case of a no-pulling-rope window curtain, the operator pushes the lower beam of the window curtain upward or downward to extend or fold the curtain.

Generally, in a conventional coreless window curtain, there is a winding device disposed inside the upper beam for winding up or release a plurality of releasing and winding straps (used for serial connection of a plurality of blades to form the curtain, and usually there are two straps), so that the lower beam can rise or fall along the winding or release of the releasing and winding straps. Normally, the movement of the lower beam is controlled by pushing the lower beam upward or pulling it downward with two hands. However, even in normal operations, there may be operational differences and the releasing and winding straps may not be smoothly winded up on the winding device, resulting in non-horizontal level of the lower beam with slight tilting. When the position of the lower beam is close to the upper beam, the non-horizontal state of the lower beam becomes more obvious. To fold up the curtain more smoothly, the user will often need to pull the lower beam downward, and then push it upward again to adjust the horizontal level of the lower beam. Such an operation is inconvenient and takes much time and effort.

In view of this, some manufacturers have developed related technologies to maintain the horizontal level of the lower beam. In most of such developments, a friction component or mechanism is disposed inside the winding device of the upper beam to control the movement of the releasing and winding straps so as to maintain the horizontal level of the lower beam. The friction component or mechanism can also prevent the curtain from falling from the highest point or bouncing from the lowest point. Such technologies can truly solve the above problem, however, the winding device to control the releasing and winding straps are all disposed inside the upper beam, with little change over the years, and using friction force to control the movement of the releasing and winding straps is unstable and unreliable. Therefore, there is still space for improvement.

For this reason, the inventor developed the winding device as shown in FIG. 1 and FIG. 2, the releasing and winding strap boxes 2 for releasing and winding the releasing and winding straps 1 are disposed inside the lower beam 3, and a motor 4 is disposed inside the lower beam 3 to connect with the releasing and winding strap boxes 2, so that the motor 4 can simultaneously control the movement of the releasing and winding straps 1, maintaining the lower beam 3 at the horizontal level at any time, and it can stop at any position. Such a configuration can replace the conventional winding device disposed inside the upper beam 5. Specifically, the motor 4 comprises a base 6, a first rope drum 7, a second rope drum 8, a spring mechanism 9, and a connecting rope 10. The base 6 is fixed on the top side inside the lower beam 3, and is disposed with a rolling shaft 11 and a connecting shaft 12 in a parallel form. The two ends of the rolling shaft 11 are respectively connected with a winding drum 13 inside the releasing and winding strap box 2. The winding drums 13 are used for releasing and winding the releasing and winding straps 1, and the first rope drum 7 and the second rope drum 8 are in a conic shape, with the surfaces of both respectively configured with a spiral rope groove 14 in a spiral form. When the first rope drum 7 rotates, the releasing and winding straps 1 can be released or winded through the rolling shaft 11 and the winding drums 13. The spring mechanism 9 is connected to one end of the first rope drum 7 and the second rope drum 8, comprising a first roller 15, a second roller 16, and an elastic piece 17. The first roller 15 and the second roller 16 are configured on one end of the rolling shaft 11 and the connecting shaft 12. The elastic piece 17 is a scroll spring with its two ends winded in opposite directions, and respectively connected with the first roller 15 and the second roller 16, to apply an elastic force for the first roller 15 and the second roller 16 to rotate in opposite directions, so that the rolling shaft 11 and the connecting shaft 12 can rotate in opposite directions. The two ends of the connecting rope 10 are connected to different ends of the first rope drum 7 and the second rope drum 8 (one end is connected to the large-diameter end 18 of the first rope drum 7, while the other end is firstly winded inside the spiral rope groove 14 and is then extended from the small-diameter end to be connected to the large-diameter end 19 of the second rope drum 8). In this way, when the first rope drum 7 and the second rope drum 8 rotate in opposite directions, it can be winded inside the spiral rope groove 14 of the first rope drum 7 or second rope drum 8. Through the elastic force of the elastic piece 17, and the varying torque of the connecting rope 10 on the first rope drum 7 and the second rope drum 8 (the varying diameters of first rope drum 7 and the second rope drum 8 will cause varying torque of the connecting rope 10), the motor 4 can control the rotation of the first rope drum 7 and the second rope drum 8, provide a power to move the releasing and winding straps 1, and enable the lower beam 3 to stop at any position.

The technology disclosed in the aforementioned patent application can truly maintain the lower beam at horizontal level at any time and enable it to stop at any position. However, when the window curtain is fully winded and fully extended, the weight load of the lower beam differs greatly. Numerous tests and actual applications have proven that the elastic piece of the motor must be specially manufactured with high-performing and durable materials to withstand the significantly different weight load and long-term use. This will greatly increase the manufacturing cost of the coreless window curtain.

### SUMMARY OF THE INVENTION

The main object of the present invention is to provide a unidirectional damper disposed inside the motor of a coreless window curtain to solve the problem caused by the significantly different weight load when the window curtain is fully winded and fully extended. This can provide practical value.

Therefore, to accomplish the aforementioned purpose, the present invention provides a unidirectional damper disposed inside the motor of a coreless window curtain. The coreless window curtain comprises an upper beam, a lower beam, and a plurality of blades serially connected between the upper beam and the lower beam using several releasing and winding straps. The motor is disposed inside the lower beam and is connected with the releasing and winding straps to control the movement of the releasing and winding straps and to keep the horizontal level of the lower beam. Through the elastic force, the releasing and winding straps can be smoothly released or winded up, and the lower beam can stop at any position. The one-way damping mechanism is disposed inside the motor to enhance the braking power of the motor.

### BRIEF DESCRIPTION OF THE DRAWINGS

FIG. 1 is a partial exploded view of the conventional coreless window curtain.

FIG. 2 is an exploded perspective of the motor inside a conventional coreless window curtain.

FIG. 3 is a combined perspective of a preferred embodiment of the present invention and the motor.

FIG. 4 is a diagrammatic view of the inside of the large-diameter end of the second rope drum in a preferred embodiment of the present invention.

FIG. 5 is a diagrammatic view of the base of the motor in a preferred embodiment of the present invention.

FIG. 6 is a diagrammatic view of the second rope drum and the shaft sleeve rotating in the direction opposite the first rope drum in a preferred embodiment of the present invention.

FIG. 7 is a diagrammatic view of the second rope drum and the shaft sleeve rotating in the direction toward the first rope drum in a preferred embodiment of the present invention.

### DETAILED DESCRIPTION OF THE INVENTION

For better understanding of the present invention, detailed descriptions are provided below with respect to a preferred embodiment and with reference to the accompanying drawings.

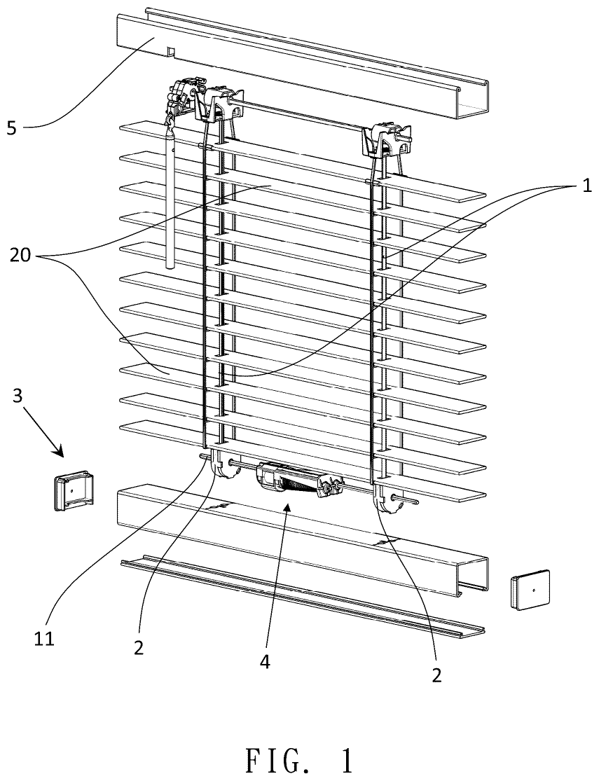

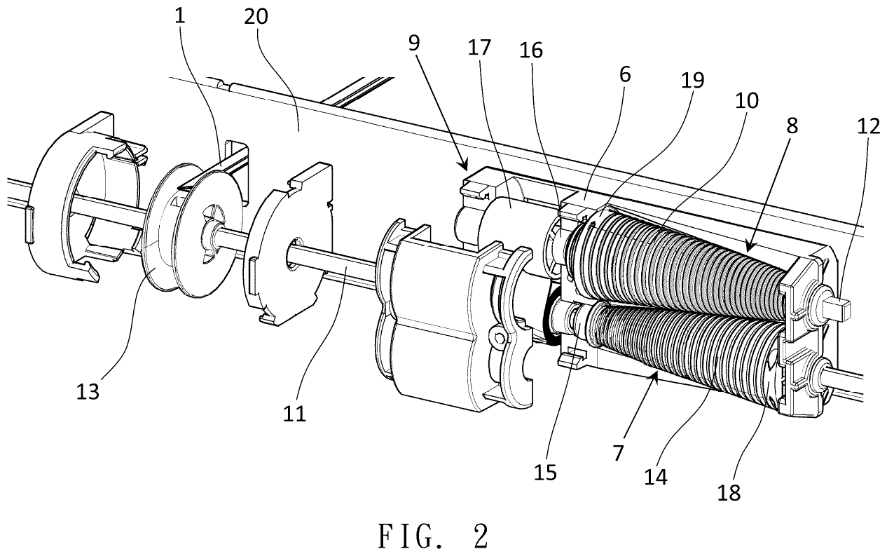

Referring to FIG. 1 and FIG. 2, the coreless window curtain comprises an upper beam 5 and a lower beam 3 arranged in parallel, a plurality of slats 20, located between the upper beam 5 and the lower beam 3 through connection by two releasing and winding straps 1. The motor 4 is configured inside the lower beam 3 and is connected with the two releasing and winding strap boxes 2 to move the two releasing and winding straps 1, so as to control the movement of the two releasing and winding straps 1, and to keep the lower beam 3 at horizontal level. Through the elastic force, the releasing and winding straps 1 can be released or winded smoothly, and the lower beam 3 can stop at any position. The unidirectional damper of the preferred embodiment according to the present invention is configured inside the motor 4 to enhance the braking force of the motor 4 to prevent the lower beam 3 from slipping. The aforementioned upper beam 5, lower beam 3, slats 20, releasing and winding straps 1, motor 4, and releasing and winding strap boxes 2 are all the same as the components of the prior-art coreless window curtain, and are known technology. Therefore, structures and operation modes of such components are not detailed herein. However, the structural composition of the motor 4 and unidirectional damper is not prior art and need to be detailed. Features of the present invention are as below:

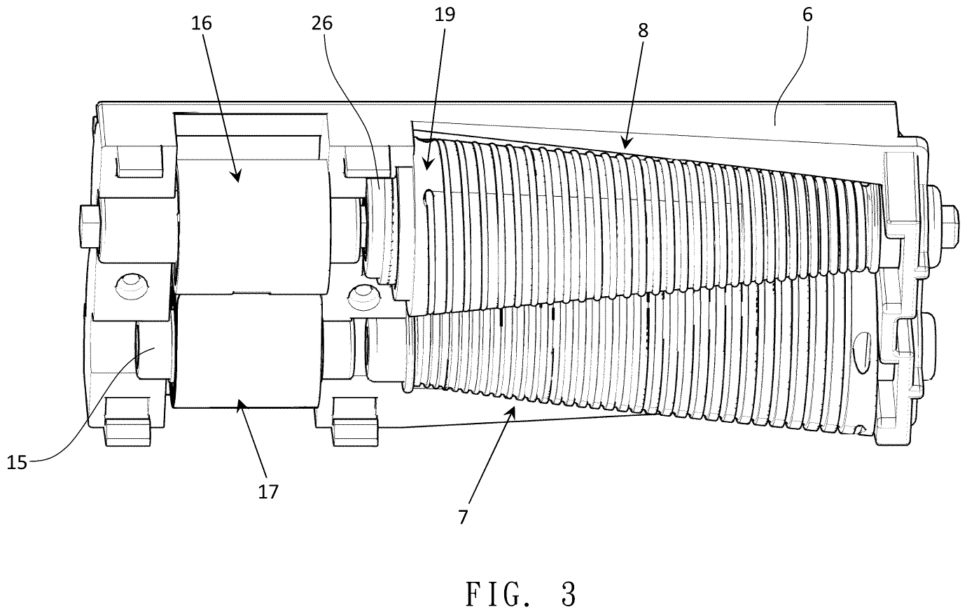

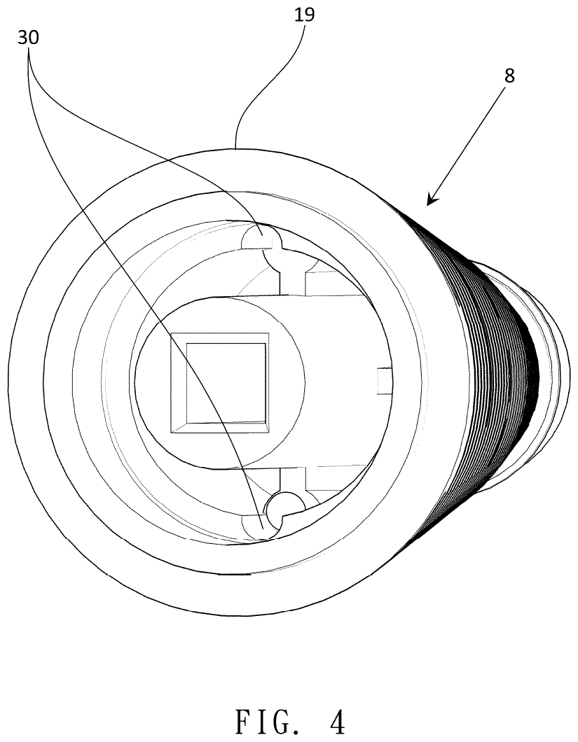

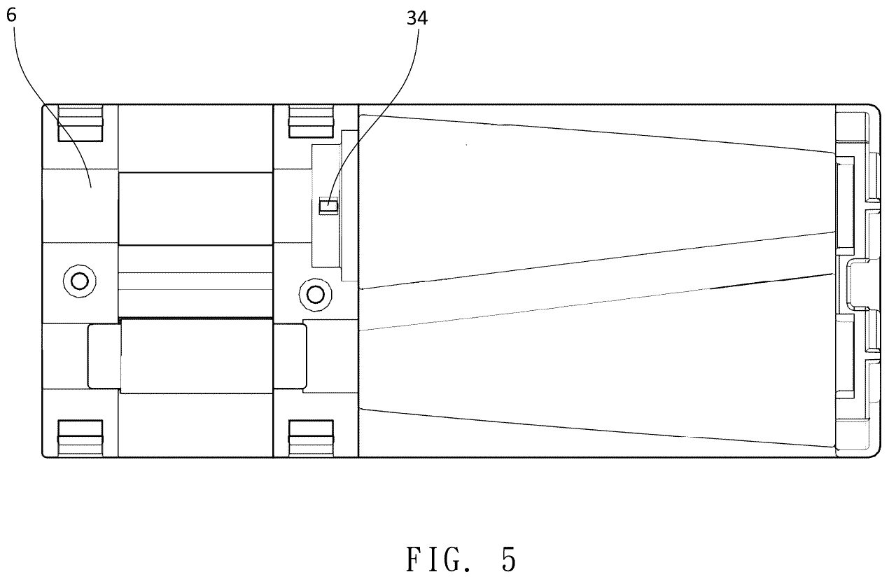

Referring to FIG. 3 to FIG. 6, the unidirectional damper comprises a clutch device 22 and a torque spring 24. The clutch device 22 comprises a shaft sleeve 26 and two clutching steel balls 28. The shaft sleeve 26 is sleeved on the connecting shaft 12 and is located inside the large-diameter end 19 of the second rope drum 8 to cooperate with the spring mechanism 8. The clutching steel balls 28 are located between the two concave holes 30 configured inside the second rope drum 8 and a wavy sliding chute 32 configured around one end of the shaft sleeve 26, and can move along the sliding chute 32. One end of the torque spring 24 is tightly fitted inside the shaft sleeve 26, while the other end is bent and inserted into the slot 34 configured on the base 6.

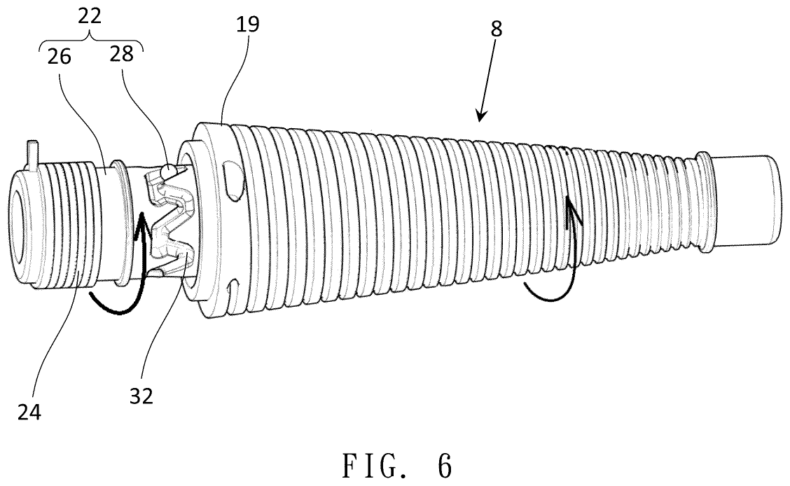

Based on this, when the user pushes the lower beam 3 upward to fold the coreless window curtain, the torque spring 24 and the shaft sleeve 26 are both in a fixed state, while under the elastic force, the elastic piece 17 inside the motor 4 will drive the second rope drum 8 (through the second roller 16 and the connecting shaft 12) to rotate in the direction opposite the first rope drum 7. As a result, the concave holes 30 inside the second rope drum 8 can drive the clutching steel balls 28 to slide inside the sliding chute 32 of the shaft sleeve 26, causing the shaft sleeve 26 to rotate in the direction opposite the first rope drum 7, as shown in FIG. 6. Consequently, the lower beam 3 can be pushed toward the upper beam, and the coreless window curtain can be folded up.

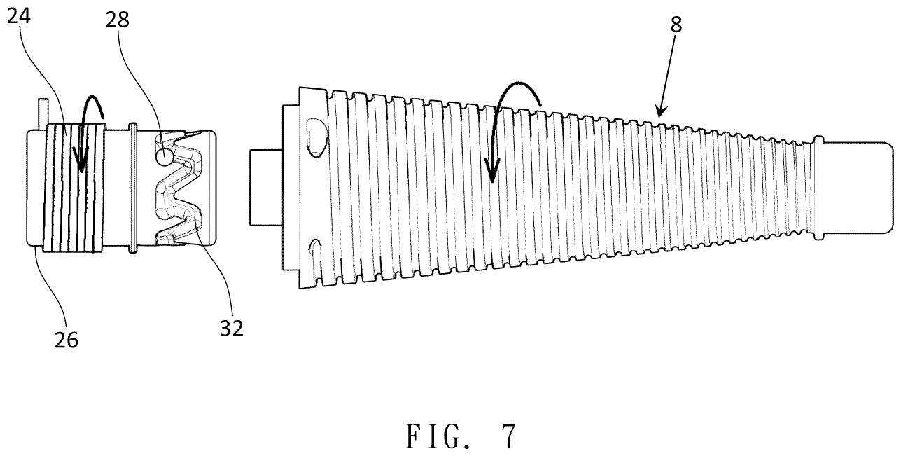

Secondly, when there is no external force, for example, the lower beam 3 is not pulled by a hand, the coreless window curtain will have a tendency to drop and extend under the force of its own weight, and will have a tendency to drive the second rope drum 8 to rotate toward the first rope drum 7, as shown in FIG. 7. As a result, the second rope drum 8 will have a tendency to drive the clutching steel balls 28 to move and cause the shaft sleeve 26 to rotate toward the first rope drum 7. However, such a tendency cannot overcome the tension between the torque spring 24 and the surface of the shaft sleeve 26 and the turning force of the elastic piece 17. Therefore, the coreless window curtain will be at rest, and the lower beam 3 will not slip and fall.

In contrary, when there is an external force, for example, when the lower beam 3 is pulled by a hand, as long as the pulling force can overcome the tension between the torque spring 24 and the surface of the shaft sleeve 26 and the turning force of the elastic piece 17, the coreless window curtain can be successfully extended. When the hand is released from the lower beam 3, it will be the above-mentioned no-external-force state, and the window curtain will immediately stop. In this way, the lower beam 3 can stop at any position.

As stated above, through the cooperation between the unidirectional damper and the motor, the present invention can truly solve the problem of substantially different weight load of the lower beam when the coreless window curtain is fully folded and fully extended. The lower beam will no longer slip and can stop at any position. As there is no need to specially manufacture the elastic piece of the motor, the manufacturing cost of the coreless window curtain can be greatly reduced. Therefore, the present invention has practical value.

What is claimed is:

1. A unidirectional damper disposed inside the motor of a coreless window curtain, wherein said coreless window curtain comprises an upper beam, a lower beam, and a plurality of slats connected between the upper beam and the lower beam using several releasing and winding straps, said motor is disposed inside the lower beam and is connected with the releasing and winding straps to control the movement of the releasing and winding straps and to maintain the balance of the lower beam, through an elastic force, the releasing and winding straps be smoothly released or winded up, and the lower beam stop at any position, the unidirectional damper is disposed inside the motor to force of braking exerted by the motor.

2. The unidirectional damper disposed inside the motor of a coreless window curtain as in claim 1, wherein said motor comprises a first rope drum, a second rope drum, a spring mechanism, and a connecting rope, the surfaces of the first rope drum and the second rope drum are respectively configured with a spiral rope groove, the first rope drum is connected with the releasing and winding straps and rotate to wind up or release the releasing and winding straps, the spring mechanism is connected to the opposite ends of the first rope drum and the second rope drum, to provide an elastic force for the first rope drum to rotate in the opposite direction of the second rope drum, the two ends of the connecting rope are respectively connected to different ends of the first rope drum and the second rope drum, and where can be winded inside the rope grooves of the first rope drum or the second rope drum when the first rope drum and the second rope drum rotate in opposite directions, the unidirectional damper is used to enhance the damping force of the motor to avoid falling of the lower beam, and comprises a clutch device and a torque spring, the clutch device is configured at the end of the second rope drum connecting the spring mechanism, one end of the torque spring is tightly fitted on the clutch device and the other end is connected with the motor.

3. The unidirectional damper disposed inside the motor of a coreless window curtain as in claim 2, wherein said motor further comprises a base, the base is fixed inside the lower beam, the first rope drum is sleeved on a rolling shaft and is propped on the base, the second rope drum is sleeved on a connecting shaft and is propped on the base in a direction parallel to the first rope drum, the connecting shaft is connected with the releasing and winding straps, the clutch device comprises a shaft sleeve and several clutching steel balls, the shaft sleeve is sleeved on the connecting shaft and positioned inside the second rope drum, the clutching steel balls are located between a concave hole configured inside the second rope drum and a sliding chute configured on one end of the shaft sleeve, and can move along the sliding chute, one end of the torque spring is tightly fitted on one end of the shaft sleeve, and the other end is connected with the base.

4. The unidirectional damper disposed inside the motor of a coreless window curtain as in claim 1, wherein said first rope drum and second rope drum are conic and comprise a large-diameter end and a small-diameter end, the first rope drum and the second rope drum are disposed in a staggered manner with the large-diameter end facing the small-diameter end, the clutch device is configured on the large-diameter end of the second rope drum.

5. The unidirectional damper disposed inside the motor of a coreless window curtain as in claim 3, wherein said first rope drum and second rope drum are conic and comprise a large-diameter end and a small-diameter end, the first rope drum and the second rope drum are disposed in a staggered manner with the large-diameter end facing the small-diameter end, the clutch device is configured on the large-diameter end of the second rope drum.

6. The unidirectional damper disposed inside the motor of a coreless window curtain as in claim 3, wherein said base is configured with a slot, and the other end of the torque spring is inserted into the slot.

7. The unidirectional damper disposed inside the motor of a coreless window curtain as in claim 3, wherein said spring mechanism is configured on the base and comprises a first roller and a second roller, said first roller and second roller being respectively connected to one end of the rolling shaft and the connecting shaft, an elastic piece, its two ends connected with the first roller and the second roller to apply an elastic force for the first roller and the second roller to rotate in opposite directions, so that the rolling shaft and the connecting shaft can rotate in opposite directions, the one-way damping mechanism being disposed on the first roller.

8. The unidirectional damper disposed inside the motor of a coreless window curtain as in claim 7, wherein said elastic piece is a scroll spring with its two ends in opposite winding directions.

9. The unidirectional damper disposed inside the motor of a coreless window curtain as in claim 3, wherein said sliding chute is disposed around one end of the shaft sleeve in a wavy form.

10. The unidirectional damper disposed inside the motor of a coreless window curtain as in claim 5, wherein the end of said torque spring other than the end inserted into the slot is in a bent form.
